(19) United States
(12) Patent Application Publication
(10) Pub. No.: US 2005/0063011 A1
(43) Pub. Date: Mar. 24, 2005

(54) Document output device and program for printing

(76) Inventor: Masaichi Sawada, Tokyo (JP)

Correspondence Address: MORRISON & FOERSTER LLP, 1650 TYSONS BOULEVARD, SUITE 300, MCLEAN, VA, 22102, US

(21) Appl. No.: 10/921,299

(22) Filed: Aug. 19, 2004

(30) Foreign Application Priority Data
Aug. 20, 2003 (JP) 2003-296679

(51) Int. Cl. G06F 15/00; H04N 1/23

(52) U.S. Cl. 358/1.18; 358/1.12

(57) ABSTRACT

A document output device, includes receiving means for receiving a printing request where user identification information is added; outputting means for outputting first, second, and third output papers in a state where the third output paper is stacked on the second output paper, the third output paper being where the total counter information is printed on a rear side surface of a third printing paper; packing means for packaging the first output, the second, and the third output papers; and total counter information indicating means for indicating the total counter information at the time when the first output paper is output and the total counter information at the time when the third output paper is output to a user requesting the printing.

### BACKGROUND OF THE INVENTION

1. Field of the Invention

The present invention relates to document output devices and software for printing which are used for printing electronic file documents.

2. Description of the Related Art

A public printer provided at a convenience store, a public print shop, or the like, is used when a user not having a printing device such as a printer prints an electronic file document. In a case where such a public printer is used for printing, the user himself usually operates the printer so as to obtain an output printed document there.

On the other hand, it is suggested that the electronic file that is a subject of printing be sent in advance from a terminal of the user to the printer or a server via the Internet so as to be printed. Even in this case, the user goes to a place where the printer is provided to perform printing so that the user obtains the output printed document there. See pages 4-5 of the Japan Laid-Open Patent Application 2003-67293.

However, in this case, since printing starts after the user arrives at the place where the public printer is provided, it is not possible to obtain the printed document immediately after the user arrives at the place where the public printer is provided. Especially, in a case where the number of the printed documents is large or there are people who arrive earlier than the user and are already performing printing and/or who are waiting for their orders, the user may have to wait for a long period of time to obtain the printed documents. On the other hand, if the printing is performed before the user arrives, the contents of the printed document may be seen by a third party.

In order to prevent the contents of the printed document from being seen by a third party, the printed document may be packaged so as to prevent the contents of the document from being known from its outside, and identification information of the user may be printed on the outside so as to be used for handing the printed document to the user. However, if the package is opened by a third party so that the contents of the document become known and then closed by the third party, the user may not know that the contents of the document are known by the third party.

### SUMMARY OF THE INVENTION

Accordingly, it is a general object of the present invention to provide a novel and useful document output device and program for printing, in which one or more of the problems described above are eliminated. Another and more specific object of the present invention is to provide a document output device and program for printing documents in a state where the user who requests printing can confirm whether a printed document is based on his request for printing.

The above-mentioned object is achieved by a document output device having a printing device and a packing device for packing a paper output from the printing device, including:
receiving means for receiving a printing request where user identification information is added;
outputting means for outputting a first output paper wherein total counter information and the user identification information are printed on a front side surface of a first printing paper, outputting a second output paper in a state where the second output paper is stacked on the first output paper, the second output paper being where a requested document based on a requirement for printing is printed, and outputting a third output paper in a state where the third output paper is stacked on the second output paper, the third output paper being where the total counter information is printed on a rear side surface of a third printing paper;
packing means for processing for packaging the first output paper, the-second output paper, and the third output paper by a package member formed by making the first output paper, the third output paper, and a package material be in a body in a state where the first output paper, the second output paper, and the third output paper are stacked; and
total counter information indicating means for indicating the total counter information at the time when the first output paper is output and the total counter information at the time when the third output paper is output to a user requesting the printing.

The above-mentioned object is also achieved by a document output device having a printing device and a packing device for packing a paper output from the printing device, including:
a receiving part configured to receive a printing request where user identification information is added,
an outputting part configured to output a first output paper wherein total counter information and the user identification information are printed on a front surface side of a first printing paper, outputting a second output paper in a state where the second output paper is stacked on the first output paper, the second output paper being where a requested document based on a requirement for printing is printed, and outputting a third output paper in a state where the third output paper is stacked on the second output paper, the third output paper being where the total counter information is printed on a rear side surface of a third printing paper;
a packing part configured to process for packaging the first output paper, the second output paper, and the third output paper by a package member formed by making the first output paper, the third output paper, and a package material be in a body in a state where the first output paper, the second output paper, and the third output paper are stacked; and
a total counter information indicating part configured to indicate the total counter information at the time when the first output paper is output and the total counter information at the time when the third output paper is output to a user requesting the printing.

The above-mentioned object is also achieved by a program for printing implemented by a document output device having a printing device and a packing device for packaging a paper output from the printing device, so that a requested document is printed by receiving a printing request and an output paper is packaged and output, the program including the steps of:
a) receiving the printing request where user identification information is added;
b) outputting a first output paper wherein total counter information and the user identification information are printed on a front side surface of a first printing paper;
c) outputting a second output paper in a state where the second output paper is stacked on the first output paper, the second output paper being where the requested document based on a requirement for printing is printed;
d) outputting a third output paper in a state where the third output paper is stacked on the second output paper, the third output paper being where the total counter information is printed on a back side surface side of a third printing paper;
e) reporting a completion of printing to the package device so as to package the first output paper, the second output paper, and the third output paper by a package member formed by making the first output paper, the third output paper, and a package material be in a body in a state where the first output paper, the second output paper, and the third output paper are stacked; and
f) indicating the total counter information at the time when the first output paper is output and the total counter information at the time when the third output paper is output to a user requesting the printing.

According to the above-mentioned invention, the second output paper where the requested document is printed can be packaged by the package material formed by making the first output paper where the total counter information and the user identification information are printed, the third output paper where the total counter information is printed, and the package material be in a body. The total counter information at the time when the first output paper is outputted and the total counter information at the time when the third output paper is output can be reported to a user requesting the printing. Therefore, the package material is peculiar in that the user identification information and information about total counters of start printing and completion of printing are indicated on the package material. Therefore, if re-printing or re-packaging is implemented, total counter information different from the total counter information indicated on the package material of the output paper printed and packaged, is indicated on the package material. The user can compare the total counter information at the time when the first output paper is output and the total counter information at the time when the third output paper is output to the user requesting the printing, and the total counter information printed on the first and third output papers. The user can confirm that the output paper packaged and designated by the user identification information is not a paper re-output or copied, by confirming that these total counter information items are the same.

In the document output device, the total counter information indicating means may include means for reporting the total counter information at the time when the first output paper is output and the total counter information at the time when the third output paper is output to the user requesting the printing.

In the document output device, the total counter information indicating part may include a part configured to report the total counter information at the time when the first output paper is output and the total counter information at the time when the third output paper is output the user requesting the printing.

In the program, the step f) may include the step of: reporting the total counter information at the time when the first output paper is output and the total counter information at the time when the third output paper is output to the user requesting the printing.

According to the above-mentioned invention, the total counter information at the time when the first output paper is output and the total counter information at the time when the third output paper is output is reported to the user. Therefore, the user can know the total counter information at the time when the first output paper is output and the total counter information at the time where the third output paper is output. The user can confirm that the output paper packaged and designated by the user identification information is not a paper re-output or copied, by comparing the total counter information at the time when the first output paper is output and the total counter information at the time when the third output paper is output, and the total counter information printed on the first and third output papers.

The document output device may further include history information storage means for storing history identification information,
wherein the total counter information indicating means may include:
means for recording the total counter information at the time when the first output paper is output and the total counter information at the time when the third output paper is output, in connection with the history identification information; and
means for accepting an input of the history identification information, and displaying the total counter information at the time when the first output paper is output and the total counter information at the time when the third output paper is output, which are recorded in the history information storage means, based on the history identification information.

The document output device may further include a history information storage part configured to store history identification information,
the total counter information indicating part may include:
a part configured to record the total counter information at the time when the first output paper is output and the total counter information at the time when the third output paper is output, in connection with the history identification information; and
a part configured to accept an input of the history identification information, and displaying the total counter information at the time when the first output paper is output and the total counter information at the time when the third output paper is output, which are recorded at the history information storage part, based on the history identification information.

In the program, the step f) may further include the steps of:
recording the total counter information at the time when the first output paper is output and the total counter information at the time when the third output paper is output, in connection with the history identification information; and
accepting an input of the history identification information, and displaying the total counter information at the time when the first output paper is output and the total counter information at the time when the third output paper is output, which are recorded at the history information storage means, based on the history identification information.

According to the above mentioned invention, it is possible to record the total counter information at the time when the first output paper is output and the total counter information at the time when the third output paper is output, in the history information storage means. Based on the input history identification information, the total counter information at the time when the first output paper is output and the total counter information at the time when the third output paper is output, are picked from the history information storage means and displayed. Therefore, the user can know the total counter information at the time when the first output paper is output and the total counter information at the time when the third output paper is output, by using the history identification information. The user can confirm that the output paper packaged and designated by the user identification information is not a paper re-output or copied, by comparing the total counter information at the time when the first output paper is output and the total counter information at the time when the third output paper is output, and the total counter information printed on the first and third output papers.

In the document output device and the program, the history identification information may be the user identification information.

According to the above mentioned invention, the user can know the total counter information at the time when the first output paper is output and the total counter information at the time when the third output paper is output, which are stored in the history information storage means, by using the history identification information.

In the document output device, the total counter information indicating means may further include:
means for producing the history identification information; and
means for reporting the history identification information to the user requesting the printing.

In the document output device, the total counter information indicating part may further include:
a part configured to produce the history identification information; and
a part configured to report the history identification information to the user requesting the printing.

In the program, the step f) may further include the steps of:
producing the history identification information; and
reporting the history identification information to the user requesting the printing.

According to the above mentioned invention, the user can know the total counter information at the time when the first output paper is output and the total counter information at the time when the third output paper is output, which are stored in the history information storage means, by using the reported history identification information.

Other objects, features, and advantages of the present invention will become more apparent from the following detailed description when read in conjunction with the accompanying drawings.

### BRIEF DESCRIPTION OF THE DRAWINGS

FIG. 1 is a schematic view of a system of an embodiment of the present invention;

FIG. 2 is a view for explaining data stored in a user information storage part;

FIG. 3 is a view for explaining data stored in a storage part for storing information about destination of output;

FIG. 4 is a view for explaining data stored in a receipt information storage part;

FIG. 5 is a schematic view of a document output device of the present invention;

FIG. 6 is a sequence diagram for explaining process steps of the embodiment of the present invention;

FIG. 7 is a flowchart for explaining process steps of the embodiment of the present invention; and

FIG. 8 is a view for explaining data stored in a printing history information storage part.

### DETAILED DESCRIPTION OF THE PREFERRED EMBODIMENTS

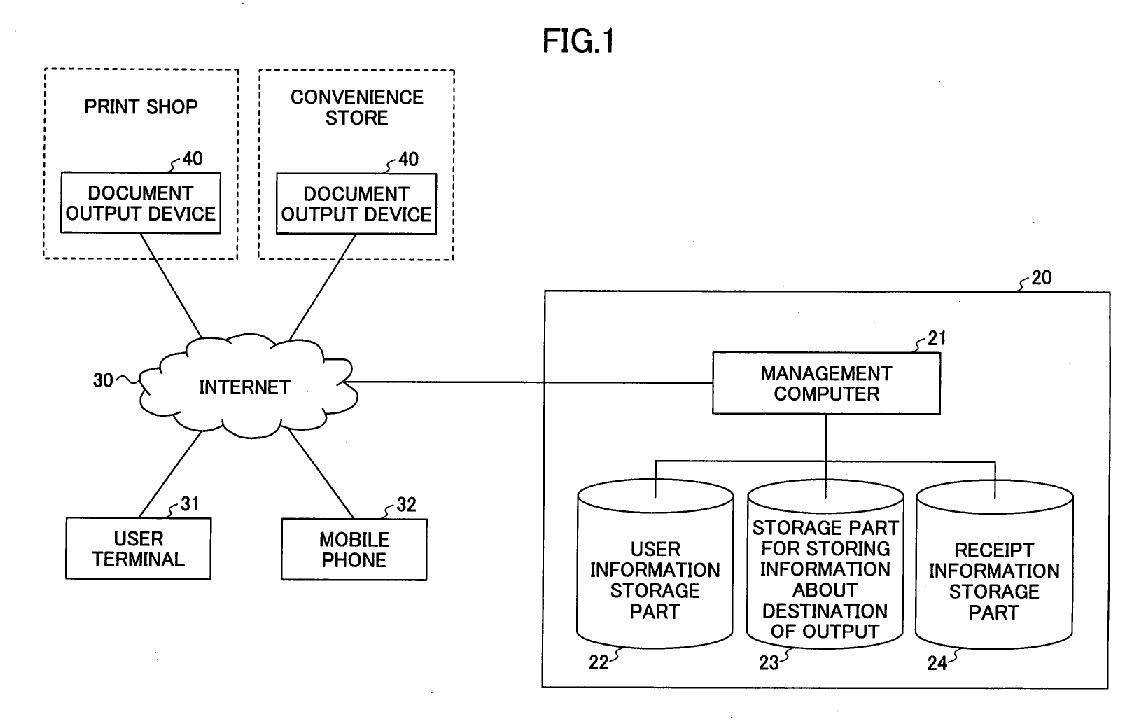

A description of a document output device and program for printing is given below, with reference to FIGS. 1 through 8 of embodiments of the present invention. More specifically, a document output device and program for printing whereby a document printed due to a printing requirement from a user terminal is packaged and it can be confirmed that the package is not opened, is one of the embodiments of the present invention.

FIG. 1 is a schematic view of a system of an embodiment of the present invention. Referring to FIG. 1, a document output device 40 which functions as printing means having packing means is provided at a print shop, a convenience store, or the like. The document output device 40 is connected to a print support server 20 and a user terminal 31 via the Internet 30.

The user terminal 31 is a computer having a control means such as a CPU (not shown), storage means such as RAM, ROM, or a hard disk, communication means, display means such as a monitor, input means such as a key board or a mouse, and others.

The document output device 40 is a public printer which receives printing data from the print support server 20 so as to print, and which is provided at a store such as the print shop or convenience store. The document output device 40 is connected to the Internet 30 and has a specific IP address. The document output device 40 receives the printing data from the print support server 20 so as to store the printing data and print the data based on an output requirement from the input means of the document output device 40. The document output device 40 further packages the output printed document.

In this embodiment, the document output device 40 implements the printing program so as to function as receiving means, output means, means for reporting completion of printing, packing means, means for reporting total counter information, and others and implements processes for printing, packaging the output paper, reporting the total counter information, and others.

That is, in this embodiment, the document output device 40 includes the receiving means, the output means, the means for reporting completion of printing, the packing means, the means for reporting total counter information, and others. The detailed structure of the document output device 40 is described below.

As shown in FIG. 1, the print support server 20 includes a management computer 21. The management computer 21 includes control means (not shown) such as a CPU, storage means such as RAM, ROM, or a hard disk, and communication means. The management computer 21 receives printing data from the user terminal 31 and searches for a document output devices 40 so as to send the printing data with a receipt number to the document output device 40 selected by the user from the searched for document output devices 40. The management computer 21 implements a print support program for the above-discussed process.

A user information storage part 22, a storage part 23 for storing information about the destination of output, and a receipt information storage part 24 are connected to the management computer 21.

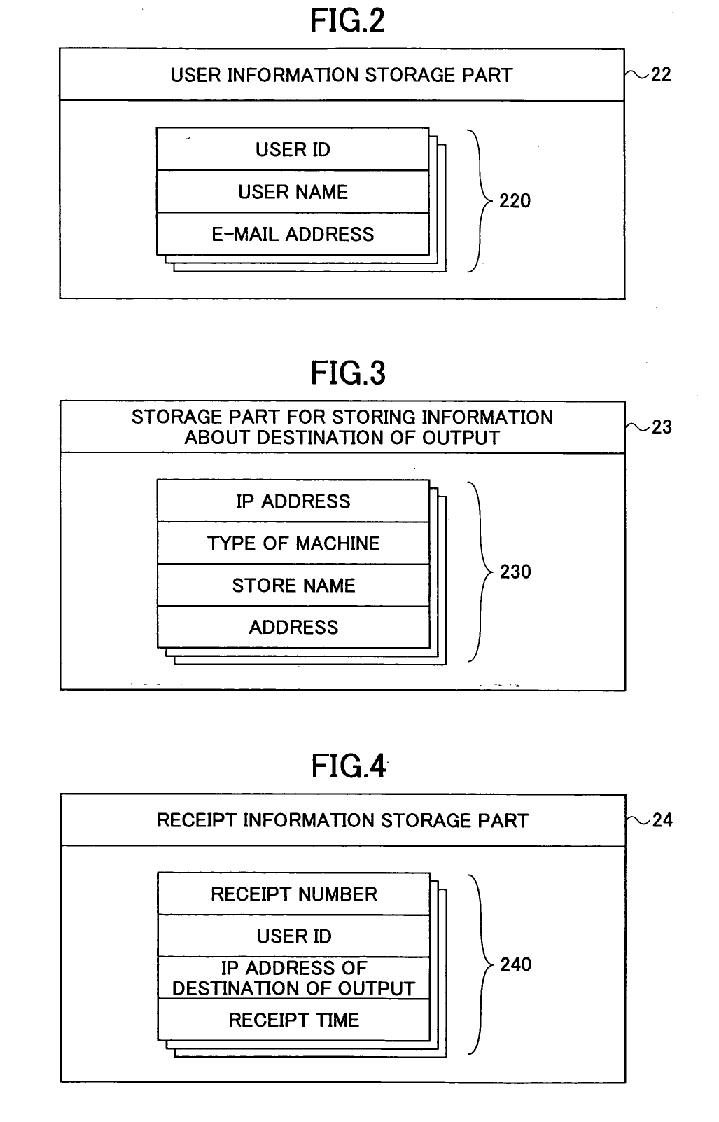

FIG. 2 is a view for explaining data stored in the user information storage part 22. As shown in FIG. 2, user information 220 is stored in the user information storage part 22 for every user. In this embodiment, the user information 220 shown in FIG. 2 includes “USER ID”, “USER NAME” and “E-MAIL ADDRESS”. “USER ID” represents an identifier for identify the user. “USER NAME” represents the name of the user. “E-MAIL ADDRESS” represents the e-mail address of a mobile phone 32 used by the user, for example. The user information 220 is stored when the user registers to receive a provision of the print support service.

FIG. 3 is a view for explaining data stored in the storage part 23 for storing information about destination of output. As shown in FIG. 3, information 230 about the destination of output is stored in the storage part 23 for storing information about the destination of output for every document output device 40. In this embodiment, the information 230 about the destination of output includes “IP ADDRESS”, “TYPE OF MACHINE”, and “STORE NAME-, “ADDRESS”. “IP ADDRESS” represents an IP address on the Internet 30 of the document output device 40, which is provided at a store such as a print shop or a convenient store. “TYPE OF MACHINE” represents a type of machine of the document output device 40. “STORE NAME” represents a name of the store where the document output device 40 is provided. “ADDRESS” represents the address of the store where the document output device 40 is provided. In this embodiment, latitude and longitude of the address of the store are set as “ADDRESS”. The information 230 about destination of output is stored at the storage part 23 in a case where the document output device 40 is registered for providing the print support service to the store where the device 40 is provided.

FIG. 4 is a view for explaining data stored in the receipt information storage part 24. As shown in FIG. 4, receipt information 240 is stored in the receipt information storage part 24 for every received request for printing. In this embodiment, the receipt information 240 includes “RECEIPT NUMBER”, “USER ID”, “IP ADDRESS OF DESTINATION OF OUTPUT” and “RECEIPT TIME”. “RECEIPT NUMBER” is an identifier for identifying a print request via the print support server 20. “USER ID” is an identifier for identifying the user. “IP ADDRESS OF DESTINATION OF OUTPUT” is the IP address on the Internet 30 of the document output device 40. “RECEIPT TIME” is the date and time when selection data of the document output device 40 are received from the user terminal 31. The receipt information 240 is recorded in a case where the management computer 21 sends the printing data to the selected document output device 40.

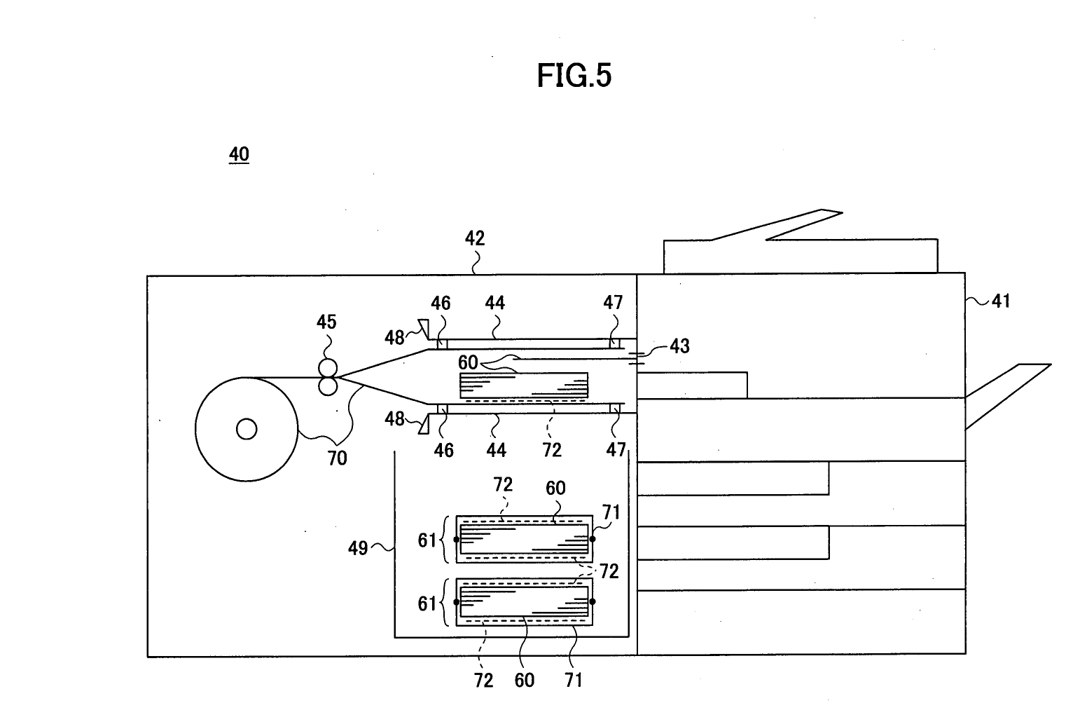

Next, the structure of the document output device 40 is discussed. The document output device 40 includes a printing device 41 and a packaging device 42. The printing device 41 includes several means as a normal printer or a multi-functional device, such as printing means (printing engine, not shown in FIG.5), control means (CPU), storage means (RAM, ROM, or the like), communication means, display means, input means, and others. The printing device 41 also includes a total counter for simply increasing a count for every output of printed papers 60. The printing device 41 discharges a printed paper 60 from a discharge opening part 43 to package material 70 as a package member expanded in a paper storage member 44 of the package device 42.

The package device 42 supports the package material 70 wound as two vinyl sheets in a roll and provided in parallel with a discharge part 43 of the printing device 41. The package device 42 sends out the package material 70 to a side of the discharge opening part 43. The package device 42 moves the package material 70 to the side of the discharge opening part 43 of the printing device 41 in the paper storage means 44 and opens a head end (separates the two sheets) of the package material 70. As described below, the package material 70 is fixed in a state where the head end of the package material 70 is opened, so that an output paper 60 can be inserted from the side of the discharge opening part 43. A couple of sending rollers 45 are provided at a side of the roll-shaped package material 70 against the paper storage means 44 so as to send the package material 70 into the paper storage means 44. The package material 70 is put between the sending rollers 45. The sending rollers 45 gradually pull out the package material 70 which is twice-bended and supported in a roll shape, so that the package material 70 is sent to the side of the paper package means 44.

Furthermore, a couple of nozzles (not shown) which face each other are fixed at a side of the paper storage means 44 of the sending roller 45, so that the package material 70 is put between the nozzles. Air flow is sent from the nozzles. Here, the Japanese Laid-Open Patent Application No. 11-115908 discloses a mechanism where a head end of a tube-shaped bag material is opened and the bag material is transformed into cylinder-shaped material by sending out air flow from the nozzles. In the present embodiment, the bag material corresponds to the package material 70 and the cylinder-shaped material corresponds to the paper storage means 44. The head end of the package material 70 is opened by the airflow sent from the nozzles and the sending rollers 45 send the package material 70 into the paper storage means 44.

When the roll-shaped package material 70 is set to the sending rollers 45, the head end of the package material 70 is slightly opened so that air flows to the inside (between the two sheets) of the package material 70. Thus, the package material 70 is put between the sending rollers 45 so that air flowing into the package material 70 works as air accumulation means and functions for opening the package material 70 passing through the sending rollers 45. The sending rollers 45 are driven so as to send out the roll-shaped package material 70 into the paper storage means 44. Furthermore, the head end of the sent package material 70 is opened by air flowing from the nozzles. The package material 70 is moved to the side of the discharge opening part 43 along internal wall surfaces of the paper storage means 44.

A pair of first heaters 46 arranged in a direction perpendicular to the longitudinal direction of the package material 70 is provided at a side of the sending rollers 45 of the paper storage means 44. The first heaters 46 are driven to approach and move away from the air-opened package material 70 by a motor for moving first heaters (not shown). The first heaters 46 heat the package material 70, which is put between the first heaters 46, so that the package material 70 can be bound in the direction perpendicular to the longitudinal direction of the package material 70. First absorption means (not shown in FIG. 5) for providing a negative pressure by control of a control part of the package device 42 is provided in the vicinity of the first heaters 46. By supplying the negative pressure to the first absorption means, the package material 70 is adhered to and supported by the first absorption means. The first absorption means goes with the first heater 46.

A pair of cutters 48 is provided at a side of the sending rollers 45 of the first heater 46. The package material 70 is put between the cutters 48. The cutters 48 approach to and move away from each other and are supported to be movably reciprocating. The cutters are tilted in a state where the edges of blades of the cutters 48 face to the inside. Each of the cutters 48 is slide-driven by a motor (not shown in FIG. 5) for driving cutters, so that the edges of the blades cut the package material 70. And then, the cutters 48 move away from each other.

A pair of second heaters 47 arranged in a direction perpendicular to the longitudinal direction of the package material 70 is provided at aside of the discharge opening part 43 of the paper storage means 44. The second heaters 47 approach and move away, driven by a motor for moving second heaters (not shown). The second heaters 47 heat the package material 70, which is put between the second heaters 47, so that the package material 70 can be bound in the direction perpendicular to the longitudinal direction of the package material 70. Second absorption means (not shown in FIG. 5) for providing a negative pressure by control of a control part of the package device 42 is provided in the vicinity of the second heaters 47. By supplying the negative pressure to the second absorption means, the package material 70 is adhered to and supported by the second absorption means. The second absorption means goes with the second heaters 47.

In this embodiment, output papers 60 provided at highest and lowest layers are unified with the package material 70 so that the output papers are packaged. More specifically, in this embodiment, output papers 60 provided at highest and lowest layers are unified with the package material 70 by thermo-compression bonding.

Because of this, the package device 42 includes thermo-compression bonding means (not shown in FIG. 5). The thermo-compression bonding means thermo-compression bonds the output papers 60 provided at highest and lowest layers among the output papers 60 discharged by the paper storage means 44, with the package material 70, respectively. In this embodiment, the package material 70 and the output papers 60 are bonded by a thermo-compression film. An adhesive is applied on external surfaces of both sides of the thermo-compression film. The adhesive adheres a subject of contact, by being heated to a designated temperature. The thermo-compression film is stored in a thermo-compression film storage means of the printing device 41 and is discharged to the paper storage means 44.

In the document output device 40, the package material 70 is supported by the paper storage means 44 of the package device 42 and then thermo-compression film is discharged from the printing device 41. After the output paper 60 is completed being output, the thermo-plastic film is further discharged from the printing device 41. In a state where the thermo-plastic film is put between the printing device 41 and the package material 70, pressure is applied from the outside of the package material 70 by the thermo-plastic means while a designated temperature is maintained. As a result of this, the output papers 60 at the highest and lowest layers are made to respectively come in contact with the package materials 70.

Furthermore, the package device 42 includes a stock part 49 for keeping a package 61 wherein the output paper 60 is packaged by a bag 71 made of-the package material 70, conveying means for conveying the package 61 to the stock part 49, and others. The conveying means conveys the package 61 to the stock part 49 by the control of the control part of the package device 42. Opening and closing means of the stock part 49 is opened by an exclusive key so that the package 61 is picked up from the stock part 49. In this embodiment, this key is maintained at the store where the document output device 40 is provided.

Operation of the package device 42 is controlled by the control part provided at the package device 42. A control part of the package device 42 is connected to the control part of the printing device 41 via the interface.

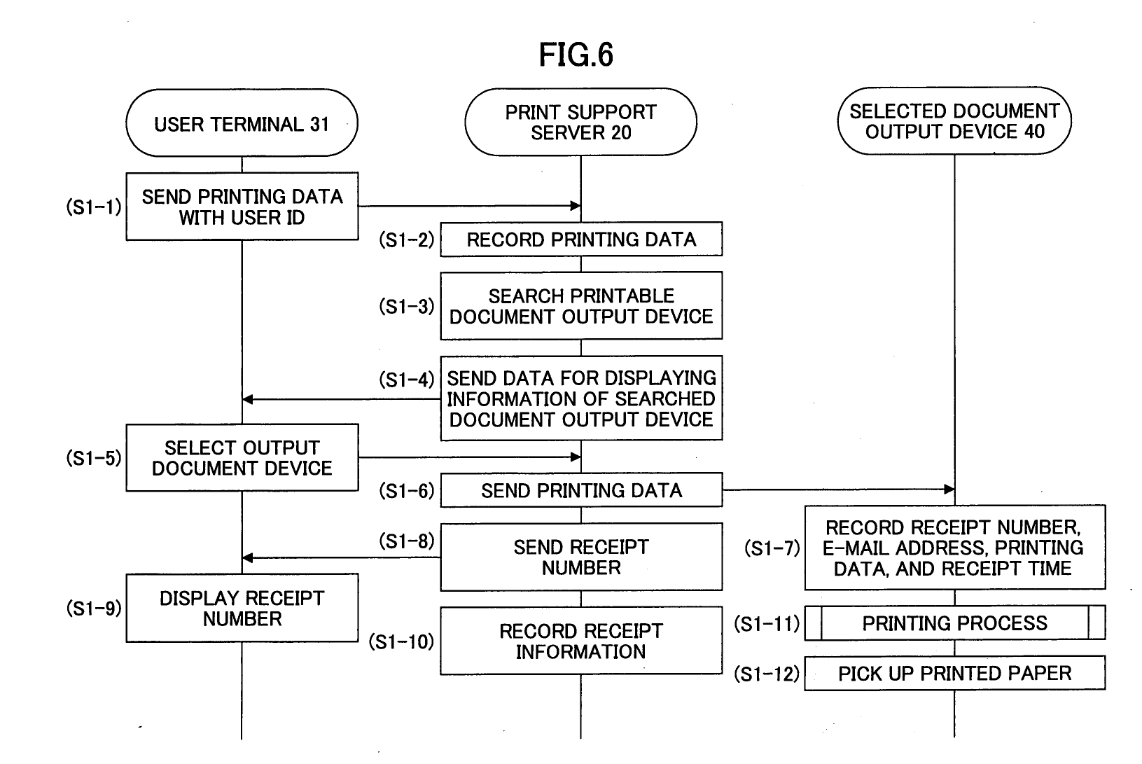

Next, the process steps whereby the selected document output device 40 prints and packages based on a printing request from the user terminal 31 in a system having the above-discussed structure is explained with reference to FIG. 6. Here, FIG. 6 is a first view for explaining process steps of the embodiment of the present invention.

In a case where the electronic file to be printed, the user first does a printing-request operation by using the user terminal 31 and following an instruction picture. Corresponding to the printing-request operation by the user, the user terminal 31 converts the electronic file subject to printing into printing data by using the printer driver. The head of the printing data includes a designation of type of machine of a printer (document output device) corresponding to the printer driver which produces the printing data, and a designation of how printing is to be done, namely one side printing or both sides printing. The user terminal 31 adds the user ID to the printing data and sends the printing data to the print support server 20 (Step Si-i). The management computer 21 of the print support server 20 receives the printing data. The management computer 21 stores the printing data in a storing part (not shown) (Step S1-2).

Next, the management computer 21 designates the latitude and longitude of the user's present position so as to search for a printable document output device 40 located within a designated distance from the user's present position (Step S1-3). More specifically, in a case where a GPS function is installed in the user terminal 31, position information acquired from the GPS function is sent from the user terminal 31 and the management computer 21 designates the latitude and longitude of the user's present position based on the position information. In a case where the GPS function is not installed in the user terminal 31, the management computer 21 receives information regarding the user's present information input at a Web page for inputting the user's present information so as to be converted into the latitude and longitude thereof. The management computer 21 picks up the information 230 about destination of output regarding the document output device 40 located within a designated distance from the user, from the latitude and longitude of the address of the information 230 about the destination of output and the latitude and longitude of the user. The management computer 21 designates the document output device 40 print-capable based on the received printing data, based on designation of type of machine included in the head of the printing data and the type of machine of the information 230 about designation of output.

The management computer 21 sends data for displaying information regarding the searched for document output devices 40 to the user terminal 31 (Step S1-4). After receiving the data, the user terminal 31 displays a picture of search results having information regarding the searched for document output devices 40. A map about the vicinity of the user, and a list of the searched for document output devices 40, are displayed on the picture of search results. In the map about the vicinity of the user, the present position of the user and the positions of the shops where the searched for document output devices 40 are provided are displayed based on the position of the user information 220 and the addresses of the information 230 about designation of output. In the list of the searched for document output devices 40, names of shops where the searched for document output devices 40 are provided and types of machines of the document output devices 40 are displayed.

After the user determines the document output device 40 for printing so as to select inputs about the device, the user terminal 31 sends the selection data regarding the document output device 40 to the print support server 20 (Step S1-5). The selection data include the user ID and IP address of the selected document output device 40.

The management computer 21 of the print support server 20 receiving the selection data gives a receipt number. The management computer 21 adds the receipt number, the user ID, the user name and e-mail address to the IP address of the selected document output device 40 and sends the printing data (Step S1-6) to the document output device 40.

The document output device 40 receiving the data records the received receipt number, the user ID, the user name, the e-mail address, the printing data, and the receipt time in the storage means of the output document device 40 (Step S1-7).

Furthermore, the management computer 21 sends the receipt number to the user terminal 31 (Step S1-8). The user terminal 31 receiving the receipt number displays the receipt number (Step S1-9). The management computer 21 record the receipt information 240 in-the receipt information storage part 24 (Step S1-10). More specifically, the management computer 21 records the receipt number of the receipt information and the user ID, based on the receipt number added to the printing data and the user ID. The IP address of the receipt information of the destination of output is recorded based on the IP address of the document output device 40 sending the printing data. In addition, the management computer 21 records the receipt time of the receipt information 240 based on time and date when receiving the selection data. The management computer 21 deletes the printing data recorded at Step S1-2.

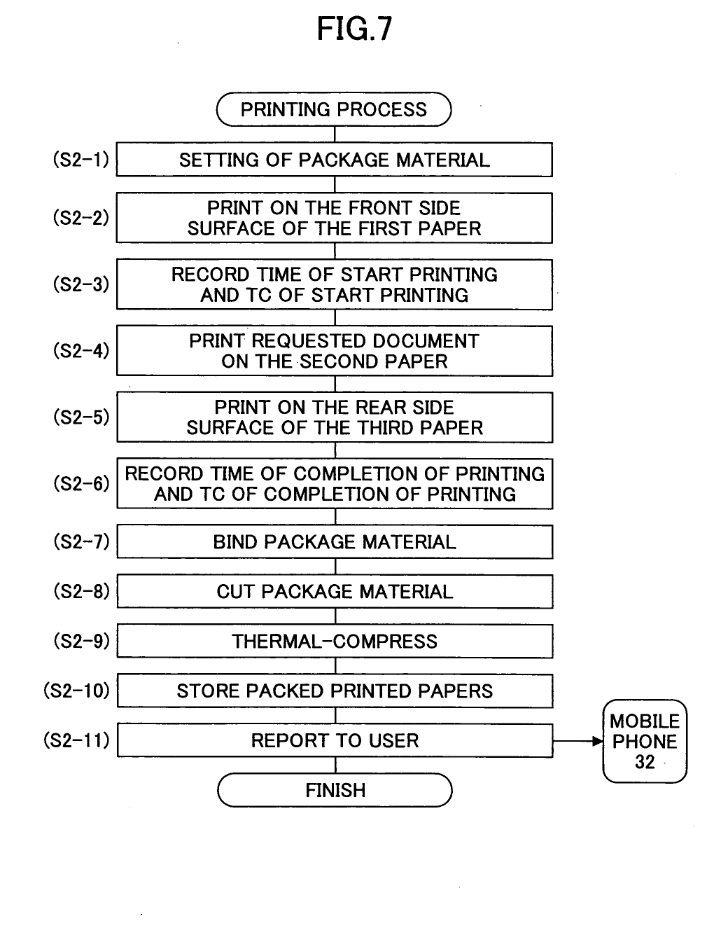

The document output device 49 implements the printing process based on the printing data, the receipt number, the user ID and the name of the user (Step S1-11). This printing process is discussed with reference to FIG. 7. Here, FIG. 7 is a second view for explaining process steps of the embodiment of the present invention.

As shown in FIG. 7, the document output device 40 which received the printing data sets the package material 70 (Step S2-1). More specifically, after the document output device 40 receives the printing data, a control part of the printing device 41 reports the receipt of the printing data to the control part of the package device 42. The control part of the package device 42 which received this report drives the sending rollers 45 by using a motor (nor shown) for controlling the sending roller so that the package material 70 is sent to the side of the paper storage means 44 by the sending rollers 45. The control part of the printing device 41 controls so that air flows from the nozzles. As a result of this, as described above, the head end of the package material 70 which is being sent is opened by the air flow from the nozzles. The package material 70 is moved to the side of the discharge opening 43 along internal wall surfaces of the paper storage means 44.

After the package material 70 is sent out so that the head end of the package material reaches a position where it comes in contact with the second heater 47, the motor for controlling sending rollers makes the sending rollers 45 stop. The control part of the package device 42 supplies negative pressure to the first absorption means of the side of the first heaters 46 and the second absorption means of the side of the second heaters 47. Because of this, the package material 70 is adhered to and supported by the first absorption means and the second absorption means. After the package material is set, the control part of the package device 42 reports the completion of setting of the package material to the control part of the printing device 41.

The printing device 41 can print on both sides of papers. The printing device 41 outputs the output paper 60 to the paper storage means 44 so that a front side surface of the output paper faces down. In a case where a plurality of the output papers 60 are output by the printing device 41, the output output papers 60 are stacked. Therefore, in the stacked output papers 60, a surface facing down is a front side surface of the output paper 60 output first and a surface facing up is the rear side surface of the output paper 60 output last.

After receiving the report of completion of the setting, the printing device 41 discharges a thermo-compression film to the paper storage means 44. The printing device 41 prints receipt number, user ID, user name, identifier of the document output device, receipt time, time of start printing, and TC (total counter) of start printing, on the front side surface of a first printing paper (Step S2-2). Here, the first printing paper is a printing paper used for printing the output paper 60 which is first output corresponding to the printing requirement. The identifier of the document output device is an identifier for designating the document output device 40. In this embodiment, a machine type of machine number of the document output device 40 is used as the identifier of the document output device. A present time of printing is printed as the time of start printing. Total counter information (TC) obtained from the total counter of the printing machine 41 is used as the TC of start printing. The printing device 41 discharges the output paper 60 as the first output paper where the above-mentioned information is printed to the paper storage means 44.

The printing device 41 records the time of start printing and TC of start printing in the storage means of the printing device 41, in connection with the user ID of the request for printing and the receipt number. (Step S2-3). Next, the printing device 41 prints the document requested to be printed (requested document) on the second printed paper based on the printing data (Step S2-4), so as to discharge the output paper 60 as the second paper where the requested document is printed, to the paper storage means 44 one by one. In this embodiment, the same kind of paper as the first printing paper is used as the second printing paper. Therefore, in this embodiment, the second printing paper is supplied from the supply tray from which the first printing paper is supplied.

Furthermore, in this embodiment, it is possible to do one-side printing and also possible to do both-sides printing as the printing of the requested document. The printing device 41 prints by following the designation of either one-side printing or both-sides printing that is set at the head of the printing data.

After printing and discharge to the paper storage means 44 of the requested document are completed, the printing device 41 prints to a rear side surface of a third printing paper. More specifically, the printing device 41 prints receipt number, user ID, user name, identifier of the document output device, receipt time, time of start printing, TC of start printing, time of completion of printing, and TC of completion of printing, on the rear side surface of the third printing paper (Step S2-5). A present time of printing is printed as the time of completion of printing. Total counter information (TC) obtained from the total counter of the printing machine 41 is used as the TC of completion of printing. The printing device 41 discharges the output paper 60 as the third output paper where the above-mentioned information is printed to the paper storage means 44. This output paper 60 is stacked on the output papers 60 stacked in the paper storage means 44 in a state where the rear side surface of this output paper 60 faces up. Therefore, the printing device 41 prints receipt number, user ID, user name, identifier of the document output device, receipt time, time of start printing, TC of start printing, time of completion of printing, and TC of completion of printing on the surface facing up of the output papers 60 stacked on the paper storage means 44.

The printing device 41 records the time of completion of printing and TC of completion of printing in the storage means of the printing device 41, in connection with the user ID of the request for printing and the receipt number (Step S2-6). The printing device 41 discharges the thermo-compression film to the paper storage means 44. This thermo-compression film is stacked on the output papers 60 stacked in the paper storage means 44. The control part of the printing device 41 sends a notice of the completion of printing to the control part of the package device 42.

The control part of the package device 42 receives the notice of the completion of printing processes for binding the package material (Step S2-7). More specifically, the control part of the package device 42 first binds the package material 70 by the first heaters 46 approaching each other by using the motor for moving first heaters so as to heat the package material 70. The control part of the package device 42 also binds the package material 70 by the second heaters 47 approaching each other by using the motor for moving second heaters so as to heat the package material 70. In this embodiment, to bind the package material 70, the output paper 60 adheres to the package material 70. Then, the control part of the package device 42 stops supplying the negative pressure to the second absorption means. The control part of the package device 42 also make the second heaters 47 move away from the package material 70 by the motor for moving second heaters.

Next, the control part of the package device 42 implements a process for cutting the package material (Step S2-8). More specifically, the control part of the package device 42 drives a cutter 48 so as to cut the package material 70 at the side of the sending rollers 45 of a part bound by the first heaters 46. As a result of this, the bag filled with the output papers 60 is cut off from the roll-shaped package material 70. Then, the control part of the package device 42 stops supplying the negative pressure to the first absorption means and also makes the first heater 46 move away by the motor for moving first heaters.

Then, the control part of the package device 42 implements a process for heat-compressing the front side surface of the first output paper and the rear side surface of the third output paper to the package material 70 (Step S2-9). More specifically, the control part of the package device 42 drives the thermo-compression means so as to push and heat the output paper 60 put between the package materials 70 of the bag 71 until the paper 60 has a designated temperature. As a result of this, the front side of the first output paper and the rear side surface of the third output paper are adhered to the package material 70.

Next, the control part of the package device 42 implements a control to store the packaged output papers 60 in the stock part 49 (Step 2-10). More specifically, the control part of the package device 42 makes the conveying part convey the package 61 from the paper storage means 44 to the stock part 49. As a result of this, the package 61 is stored in the stock part 49. Then, the control part of the package device 42 sends a notice of the completion of packaging to the control part of the printing device 41.

After receiving the notice of the completion of packing, the printing device 41 sends the identifier of the document output device, the receipt time, time of start printing, TC of start printing, time of completion of printing, and TC of completion of printing, to the user (Step S2-11). More specifically, the printing device 41 send the identifier of the document output device, the receipt time, time of start printing, TC of start printing, time of completion of printing, and TC of completion of printing, to the e-mail address recorded corresponding to the printing request. Here, in a case where an e-mail address of the mobile phone 32 is recorded, this e-mail is sent to-the mobile phone 32.

The user knows that printing is completed by the e-mail received by the mobile phone 32. The user confirms the receipt time, time of start printing, TC of start printing, time of completion of printing, and TC of completion of printing, by this e-mail.

The printing device 41 deletes the receipt number, user ID, user name, e-mail address, and the printing data recorded at the storage means of the document output device 40, regarding the print request wherein a printing process is completed.

The user goes to the shop where the selected document output device 40 is located. The user provides the user ID and the receipt number to a clerk and requests to pick up the package 61. The clerk opens the opening and closing means of the stock part 49 by using a key exclusively for opening and closing the stock part 49. The clerk compares the user ID and the receipt number provided by the user and the user ID and the receipt number printed on an external surface of the package, respectively, so as allow the user to pick up the corresponding package 61 from the stock part 49 of the document output device 40 (Step S1-12). The clerk hands the picked package 61 to the user in exchange for a fee for printing.

As described above, the receipt time, time of start printing, TC of start printing, time of completion of printing, and TC of completion of printing, can be confirmed from the external surface of the package 61. The user confirms whether the receipt time, time of start printing, TC of start printing, time of completion of printing, and TC of completion of printing that are reported by e-mail are consistent with the receipt time, time of start printing, TC of start printing, time of completion of printing, and TC of completion of printing that are indicated on the package 61.

According to the above-mentioned embodiment, the following effect can be achieved.

In this embodiment, the document output device 40 outputs the output paper 60 (the first output paper). The TC of start printing and others are printed on the front side surface of the first paper.

Then, the document output device 40 outputs the output paper 60 (the second output paper) so that the second paper is stacked on the first paper. The requested document based on the request for printing is printed on the second paper. Then, the document output device 40 outputs the output paper 60 (the third output paper) so that the third paper is stacked on the second paper. The TC of completion of printing and others-are printed on the rear side surface of the third paper. The first output paper and the third output paper are thermal-compressed by the package material 70 so that the first output paper, the third output paper, and the package material 70 are made in a body. The second output paper put between the first output paper and the third output paper is packaged by the bag 71 made of the package material 70 formed by making the first output paper and the third output paper in a body. The document output device 40 reports the information regarding the TC of start printing and the TC of completion of printing.

Accordingly, the bag 71 peculiar to each request for printing, which forms one body with the output papers 60 where the TC of start printing and the TC of completion of printing are printed, is used for the package 61 of the printed requested document. Since the vinyl package material 70 and the output papers 60 are adhered to each other, it is difficult to open the package 61 and then repack the package 61 by using the same bag 71.

Furthermore, since the total counter information simply increases corresponding to printing, even if reprinting is implemented, a different TC of start printing and-a different TC of completion of printing are printed. Therefore, it is not possible to make another package 61 using the same bag 71. Therefore, the user can confirm whether the package 61 is re-output by the same document output device 4.0 by comparing the reported TC of start printing and TC of completion of printing and the TC of start printing and TC of completion of printing, respectively, indicated on the package 61.

In the embodiment, the document output device 40 prints the identifier of the document output device 40 on the front side surface of the first output paper and the rear side surface of the third output paper. The document output device 40 reports the identifier of the document output device 40 to the user. Therefore, in a case where the reported identifier of the document output device is consistent with the identifier of the document output device indicated on the package 61, it can be confirmed that the package 61 is output by the document output device 40 designated by the reported identifier of the document output device. In a case where the reported TC of start printing and TC of completion of printing are consistent with the reported TC of start printing and TC of completion of printing indicated on the package 61, it still can be that the reported TC of start printing and TC of completion of printing are made consistent by using a different document output devices 40.

In this embodiment, in addition to the reported TC of start printing and TC of completion of printing, the time of start printing and time of completion of printing are printed on the front side surface of the first output paper and the rear side surface of the third output paper by the document output device 40. The document output device 40 reports the time of start printing and time of completion of printing in addition to the reported TC of start printing and TC of completion of printing to the user. Accordingly, the user can confirm the time of start printing and time of completion of printing by comparing the reported contents and contents indicated on the package 61 so as to confirm whether the package 61 contains the output paper 60 output at the time.

In this embodiment, the TC of start printing, the TC of completion of printing, and others are sent to the e-mail address used by the mobile phone 32. Hence, in a case where it takes-time from request for printing to completion of printing, the user can receive e-mail by using the mobile phone 32 so as-to know the TC of start printing and the TC of completion of printing. Therefore, as long as the user has the mobile phone 32 with him, there is no need to wait by the user terminal 31 from the request for printing time to the receipt of the e-mail regarding the TC of start printing, the TC of completion of printing, and others.

In this embodiment, after sending the printing data and others to the document output device 40, the management computer 21 deletes the printing data recorded in the management computer 21. The printing device 41 deletes the receipt number, user ID, user name, e-mail address, and the printing data recorded at the storage means of the document output device 40, regarding the print request wherein a printing process is completed. Therefore, it is possible to prevent re-printing the print request which printing process is completed.

Furthermore, in a case where the package 61 is made by using the document output device 40 as a copier, the TC of start printing, TC of completion of printing, and others are printed at the time of copying, so that the TC of start printing and the TC of completion of printing indicated on the package 61 made by the copier are different from the originals. Accordingly, even if the third party re-makes the package 61 by opening the package 61 and copying, the user can know about the fact of copying by comparing the printed TC of start printing, the TC of completion of printing, and others with the reported TC of start printing, the TC of completion of printing, and others. Therefore, if the printed TC of start printing, the TC of completion of printing, and others are consistent with the reported TC of start printing, the TC of completion of printing, and others, the user can know the printed papers are not copied.

The above-discussed embodiment may be modified as follows. That is, in-this embodiment, the user compares the reported TC of start printing, the TC of completion of printing, and others with the TC of start printing, the TC of completion of printing, and others indicated on the package 61. Instead of this, the TC of start printing, the TC of completion of printing, and others that are compared with the TC of start printing, the TC of completion of printing, and others indicated on the package 61 may be obtained at a place where the document output device 40 is located.

For example, in a case where the user inputs the user ID and the receipt number, the TC of the start printing, the TC of completion of printing, and others may be displayed at the display part of the document output device 40.

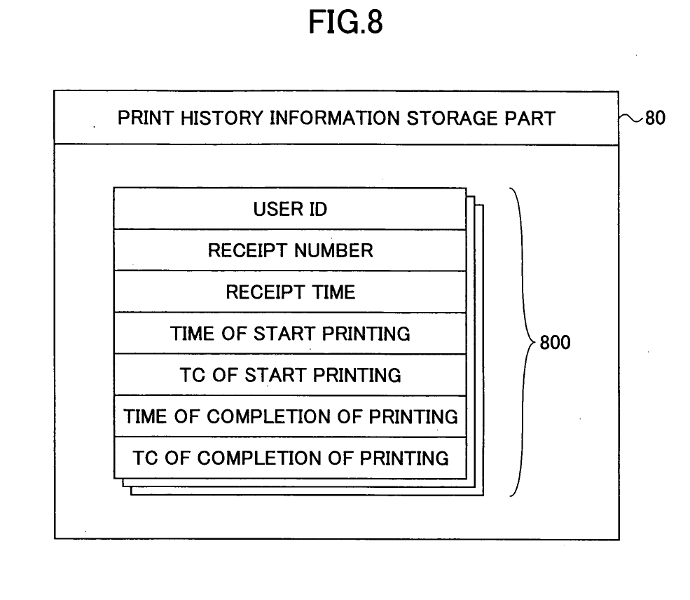

In this case, for example, the document output device 40 includes a print history information storage part 80 shown in FIG. 8 as history information storage means. As shown in FIG. 8, print history information 800 is stored in the print history information storage part 80 for every print request. The print history information 800 includes user ID, receipt number, receipt time, time of start printing, TC of start printing, time of completion of printing, and TC of completion of printing. The print history information 800 is recorded when the requested document is printed. More specifically, when the requested document is received, the user ID, the receipt number and the receipt time are recorded. When the front side surface of the first printing paper is printed, the time of start printing and the TC of start printing are recorded. When the rear side surface of the third printing paper is printed, the time of completion of printing and the TC of completion of printing are recorded. The document output device 40 receives inputs of the user ID and the receipt number, picks up the print history information 800 from the print history information storage part 80, and displays the receipt time, the time of start printing, the TC of start printing, the time of completion of printing, and the TC of completion of printing on the display part of the document output device 400.

The user compares the TC of start printing, the TC of completion of printing, and others displayed by the document output device 40 and the TC of start printing, the TC of completion of printing, and others printed at the first output paper and third output paper adhered to the bag 71.

Because of this, the user can know the TC of start printing, the TC of completion of printing, and others corresponding to his print request even in a state where e-mail cannot be used. Therefore, even if the user not having the mobile phone 32 leaves for the place where the document output device 40 is located before the report of information regarding the TC of start printing, the TC of completion of printing, and others is received by the user terminal 31, the user can know the TC of start printing, the TC of completion of printing, and others corresponding to his print request. Furthermore, the user can compare the reported TC of start printing, the TC of completion of printing, and others and the TC of start printing, the TC of completion of printing, and others indicated on the package 61.

In this embodiment, the use can compare the reported TC of start printing, the TC of completion of printing, and others that are reported to the user. In addition, the user can compare the reported TC of start printing, the TC of completion of printing, and others and the TC of start printing, the TC of completion of printing, and others printed at the first output paper and third output paper adhered to the bag 71. Instead of this, the history identification information used for identifying the history information recorded at the document output device 40 may be made and sent without reporting the TC of start printing, the TC of completion of printing, and others by e-mail. In this case the document output device 40 records the TC of start printing, the TC of completion of printing, and others, in connection with the history identification information. The document output device 40 displays the TC of start printing, the TC of completion of printing, and others of print history designated by the history identification information. The user compares the TC of start printing, the TC of completion of printing, and others displayed by the document output device 40 and the TC of start printing, the TC of completion of printing, and others printed at the first output paper 60 and third output paper 60 adhered to the bag 71.

Thus, the user can confirm the TC of start printing, the TC of completion of printing, and others stored at the storage means of the document output device 40 by using the history identification information reported by the e-mail. The user can compare the TC of start printing, the TC of completion of printing, and others confirmed based on the history identification information and the TC of start printing, the TC of completion of printing, and others printed. In this case, since the user ID and the receipt number are not recorded as history information, a third party can be prevented from obtaining the data regarding the user ID and the receipt number from the storage means of the document output device 40 after printing.

In the above-discussed embodiment, the document output device 40 directly sends the e-mail where the TC of start printing and the TC of completion of printing are described to the mobile phone 32. Instead of this, the document output device 40 may report the TC of start printing, the TC of completion of printing, and others to the print support server 20 and send the e-mail where the TC of start printing and the TC of completion of printing are described to the mobile phone 32.

In this embodiment, the output paper 60 is packaged by the tube-shaped vinyl package material 70. Instead of this, the output paper 60 may be packaged by other methods and by other package material. For example, the package material may have a bag configuration in advance.

In this embodiment, the package material 70 is used separately from the output paper 60 (the first output paper) where the TC of start printing is printed and the output paper 60 (the third output paper) where the TC of completion of printing is printed. In addition, the output paper 60 (the second output paper) where the requested document is printed is put between the first output paper and the third output paper so as to be packaged by using the bag 71 formed by making the first output paper, the third output paper, and the package material 70 be in a body. Instead of this, the second paper may be put between the first output paper and the third output paper and packaged by sticking together the first output paper and the third output paper.

Furthermore, in this embodiment, the document output device 40 is publicly located at the convenience store. The document output device 40 may not be public. For example, a printer as the document output device may be located within a building of a company and used by a specific user such as a staff member of the company.

The present invention is not limited to these embodiments, but variations and modifications may be made without departing from the scope of the present invention.

This patent application is based on Japanese Priority Patent Application No. 2003-296679 filed on Aug. 20, 2003, the entire contents of which are hereby incorporated by reference.

1. A document output device having a printing device and a packing device for packing a paper output from the printing device, comprising:
receiving means for receiving a printing request where user identification information is added;
outputting means for outputting a first output paper wherein total counter information and the user identification information are printed on a front side surface of a first printing paper, outputting a second output paper in a state where the second output paper is stacked on the first output paper, the second output paper being where a requested document based on a requirement for printing is printed, and outputting a third output paper in a state where the third output paper is stacked on the second output paper, the third output paper being where the total counter information is printed on a rear side surface of a third printing paper;
packing means for processing for packaging the first output paper, the second output paper, and the third output paper by a package member formed by making the first output paper, the third output paper, and a package material be in a body in a state where the first output paper, the second output paper, and the third output paper are stacked; and
total counter information indicating means for indicating the total counter information at the time when the first output paper is output and the total counter information at the time when the third output paper is output to a user requesting the printing.

2. The document output device as claimed in claim 1,
wherein the total counter information indicating means includes means for reporting the total counter information at the time when the first output paper is output and the total counter information at the time when the third output paper is output to the user requesting the printing.

3. The document output device as claimed in claim 1,
further comprising history information storage means for storing history identification information,
wherein the total counter information indicating means includes:
means for recording the total counter information at the time when the first output paper is output and the total counter information at the time when the third output paper is output, in connection with the history identification information; and
means for accepting an input of the history identification information, and displaying the total counter information at the time when the first output paper is output and the total counter information at the time when the third output paper is output, which are recorded in the history information storage means, based on the history identification information.

4. The document output device as claimed in claim 3,
wherein the history identification information is the user identification information.

5. The document output device as claimed in claim 3,
wherein the total counter information indicating means further includes:
means for producing the history identification information; and
means for reporting the history identification information to the user requesting the printing.

6. A document output device having a printing device and a packing device for packing a paper output from the printing device, comprising:
a receiving part configured to receive a printing request where user identification information is added;
an outputting part configured to output a first output paper wherein total counter information and the user identification information are printed on a front surface side of a first printing paper, outputting a second output paper in a state where the second output paper is stacked on the first output paper, the second output paper being where a requested document based on a requirement for printing is printed, and outputting a third output paper in a state where the third output paper is stacked on the second output paper, the third output paper being where the total counter information is printed on a rear side surface of a third printing paper;
a packing part configured to process for packaging the first output paper, the second output paper, and the third output paper by a package member formed by making the first output paper, the third output paper, and a package material be in a body in a state where the first output paper, the second output paper, and the third output paper are stacked; and
a total counter information indicating part configured to indicate the total counter information at the time when the first output paper is output and the total counter information at the time when the third output paper is output to a user requesting the printing.

7. The document output device as claimed in claim 6,
wherein the total counter information indicating part includes a part configured to report the total counter information at the time when the first output paper is output and the total counter information at the time when the third output paper is output the user requesting the printing.

8. The document output device as claimed in claim 6,
further comprising a history information storage part configured to store history identification information,
wherein the total counter information indicating part includes:
a part configured to record the total counter information at the time when the first output paper is output and the total counter information at the time when the third output paper is output, in connection with the history identification information; and
a part configured to accept an input of the history identification information, and displaying the total counter information at the time when the first output paper is output and the total counter information at the time when the third output paper is output, which are recorded at the history information storage part, based on the history identification information.

9. The document output device as claimed in claim 8,
wherein the history identification information is the user identification information.

10. The document output device as claimed in claim 8,
wherein the total counter information indicating part further includes:
a part configured to produce the history identification information; and
a part configured to report the history identification information to the user requesting the printing.

11. A program for printing implemented by a document output device having a printing device and a packing device for packaging a paper output from the printing device, so that a requested document is printed by receiving a printing request and an output paper is packaged and output, the program comprising the steps of:
a) receiving the printing request where user identification information is added;
b) outputting a first output paper wherein total counter information and the user identification information are printed on a front side surface of a first printing paper;
c) outputting a second output paper in a state where the second output paper is stacked on the first output paper, the second output paper being where the requested document based on a requirement for printing is printed;
d) outputting a third output paper in a state where the third output paper is stacked on the second output paper, the third output paper being where the total counter information is printed on a back side surface side of a third printing paper;
e) reporting a completion of printing to the package device so as to package the first output paper, the second output paper, and the third output paper by a package member formed by making the first output paper, the third output paper, and a package material be in a body in a state where the first output paper, the second output paper, and the third output paper are stacked; and
f) indicating the total counter information at the time when the first output paper is output and the total counter information at the time when the third output paper is output to a user requesting the printing.

12. The program for printing as claimed in claim 11,
wherein the step f) includes the step of:
reporting the total counter information at the time when the first output paper is output and the total counter information at the time when the third output paper is output to the user requesting the printing.

13. The program for printing as claimed in claim 11,
wherein the step f) further includes the steps of:
recording the total counter information at the time when the first output paper is output and the total counter information at the time when the third output paper is output, in connection with the history identification information; and
accepting an input of the history identification information, and displaying the total counter information at the time when the first output paper is output and the total counter information at the time when the third output paper is output, which are recorded at the history information storage means, based on the history identification information.

14. The document output device as claimed in claim 13,
wherein the history identification information is the user identification information.

15. The document output device as claimed in claim 13,
wherein the step f) further includes the steps of:
producing the history identification information; and
reporting the history identification information to the user requesting the printing.
